(19) United States
(12) Patent Application Publication
(10) Pub. No.: US 2022/0158489 A1
(43) Pub. Date: May 19, 2022

(54) PORTABLE WIRELESS CHARGER WITH WIRELESS CHARGING BASE

(71) Applicant: Kyla Wilkinson, Southwest Ranches, FL (US)

(72) Inventor: Kyla Wilkinson, Southwest Ranches, FL (US)

(21) Appl. No.: 17/529,664

(22) Filed: Nov. 18, 2021

Related U.S. Application Data
(60) Provisional application No. 63/115,177, filed on Nov. 18, 2020.

(51) Int. Cl. H02J 50/00; H02J 50/80; H02J 7/00

(52) U.S. Cl. CPC H02J 50/005; H02J 7/0044; H02J 50/80

(57) ABSTRACT

A portable charger for an electronic device is disclosed, including a wireless charging base configured to store supplemental power and transmit the supplemental power to a portable wireless charger. The portable wireless charger is in electrical communication with the wireless charging base. The portable wireless charger is configured to wirelessly transmit the stored supplemental power wirelessly to an electronic device. The portable wireless charger is releasably engaged to the wireless charging base.

### CROSS-REFERENCE TO RELATED APPLICATIONS

The present application claims priority to U.S. Provisional Application No. 63/115,177 filed Nov. 18, 2020, titled “PORTABLE POWER STORAGE AND WIRELESS CHARGING DEVICE,” which is hereby incorporated by reference in its entirety.

### TECHNICAL FIELD

The embodiments generally relate to accessories for personal electronic devices and, more particularly, relate to portable power supplies with an integrated wireless charger.

### BACKGROUND

Smartphone and similar handheld computing devices have become increasingly popular in modern society. As the capabilities have advanced in such devices, their need for adequate power supplies which can deliver power for long periods of time has increased. Often, batteries degrade over time and lose their ability to adequately power the device throughout an entire day.

Replacing the battery integrated within the device may be difficult and expensive to perform. In some devices, replacing the battery is not possible, requiring the user to replace the entire device, which is not only wasteful, but may be prohibitively expensive for some users. In other devices where it is possible to replace the battery, doing so may itself be prohibitively expensive due to the cost of parts of labor necessary.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

A portable charger for an electronic device is disclosed, including a wireless charging base configured to store supplemental power and transmit the supplemental power to a portable wireless charger. The portable wireless charger is in electrical communication with the wireless charging base. The portable wireless charger is configured to wirelessly transmit the stored supplemental power wirelessly to an electronic device. The portable wireless charger is releasably engaged to the wireless charging base.

The device provides wirelessly transmitted supplemental power to extend the overall battery life of the electronic device. The device can be easily transported while attached to the electronic device during daily activities.

The device may operate in a connected configuration or a disconnected configuration, such that the portable wireless charger can be easily transported and provide portable wireless charging without the portable wireless charger needing to be plugged in to electrical power.

In one aspect, the device includes a housing which forms a protective barrier to the electrical components and power storage.

In one aspect, the portable power supply is disposed within the housing and the wireless charger is disposed on the exterior of the housing.

In one aspect, the portable wireless charger and the wireless charging base are releasably engaged via a male port position on the wireless charging base and a female port on the portable wireless charger.

In one aspect, the portable wireless charger includes a front side, the front side including a charging indicator.

In one aspect, the charging indicator is comprised of a plurality of LED's.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the portable wireless charger and wireless charging base, according to some embodiments;

FIG. 2 illustrates a perspective view of the portable wireless charger and wireless charging base, wherein the portable wireless charger is mounted on an electronic device to provide wireless charging thereto, according to some embodiments;

FIG. 3 illustrates a perspective view of the portable wireless charger and wireless charging base, according to some embodiments;

FIG. 4 illustrates an exploded view of the portable wireless charger and wireless charging base, according to some embodiments;

FIG. 5 illustrates a side elevation view of the portable wireless charger and wireless charging base, according to some embodiments;

FIG. 6 illustrates a side elevation view of the portable wireless charger wireless charging base, according to some embodiments;

FIG. 7 illustrates a front side elevation view of the portable wireless charger and wireless charging base, according to some embodiments;

FIG. 8 illustrates a rear side elevation view of the portable wireless charger and wireless charging base, according to some embodiments;

FIG. 9 illustrates a bottom plan view of the portable wireless charger and wireless charging base, according to some embodiments; and

FIG. 10 illustrates a top plan view of the portable wireless charger and wireless charging base, according to some embodiments.

### DETAILED DESCRIPTION

The specific details of the single embodiment or variety of embodiments described herein are to the described apparatus. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the apparatus. Accordingly, the apparatus components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The specific details of the single embodiment or variety of embodiments described herein are set forth in this application. Any specific details of the embodiments are used for demonstration purposes only, and no unnecessary limitation or inferences are to be understood therefrom. Furthermore, as used herein, relational terms, such as “first” and “second,” “top” and “bottom,” and the like, may be used solely to distinguish one entity or element from another entity or element without necessarily requiring or implying any physical or logical relationship, or order between such entities or elements.

As used herein, the term “electronic device” may relate to any suitable electronic devices such as power adapters, wristwatches, cellular telephones or other handheld devices, laptop computers, tablet computers, accessories such as earbuds, electronic pencils (e.g., a stylus), or computer mice, other portable electronic devices, and/or other electronic equipment.

In general, the embodiments provided herein relate to a portable wireless charger and wireless charging base (hereinafter collectively referred to as “device” or “the device”, which can be readily transported during daily activities to provide supplemental power to an electronic device. The electronic device may include control circuitry and wireless power circuitry. The electronic devices may also have additional components such as input-output devices, batteries, and/or other circuitry. The wireless charger releasably engaged with the portable power storage device

FIG. 1 illustrates a perspective view of the device 100 comprised of the portable wireless charger 101 and wireless charging base 103. The wireless charging base 103 includes a first port 105 which receives electrical wiring (not shown) to supply power to the wireless charging base 103. The wireless charging base 103 includes a power storage 107 (e.g., a rechargeable battery) which stores power received from the electrical wiring to store power and transmit power to the portable wireless charger 101 when in the connected configuration 109 shown in FIG. 1. The wireless charging base 103 includes a top surface 111 and a bottom surface 113. The bottom surface 113 at least partially receives the portable wireless charger 101 to supply power thereto when in the connected configuration 109.

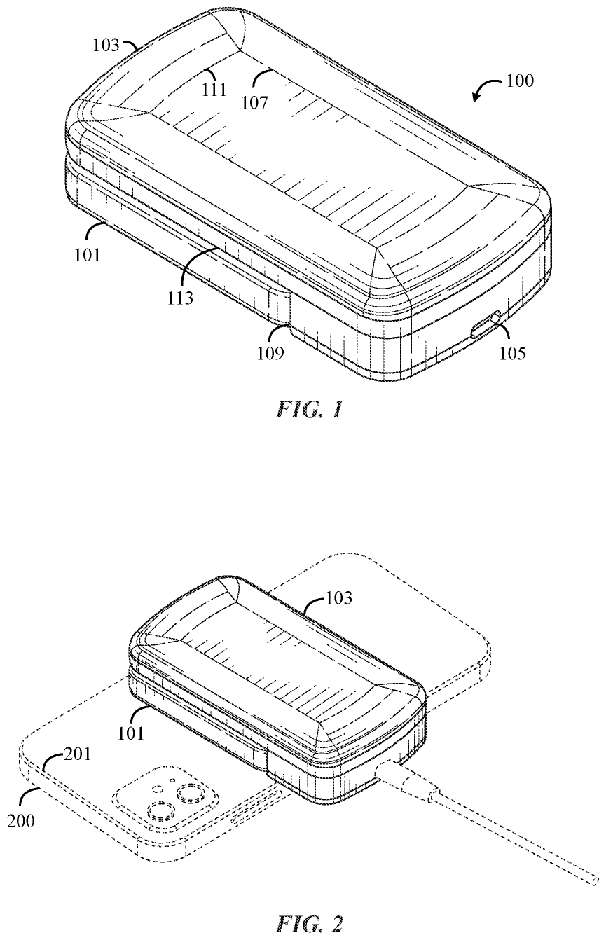

FIG. 2 illustrates a perspective view of the portable wireless charger 101 and wireless charging base 103, wherein the portable wireless charger 101 is mounted on an electronic device 200 to provide continuous wireless charging thereto when in the connecting configuration. Alternatively, the portable wireless charger 101 may supply power to the electronic device 200 when not in the connected configuration. To charge the electronic device 200, the portable wireless charger 101 is positioned to contact the back 201 of the electronic device 200 to supply wireless charging thereto.

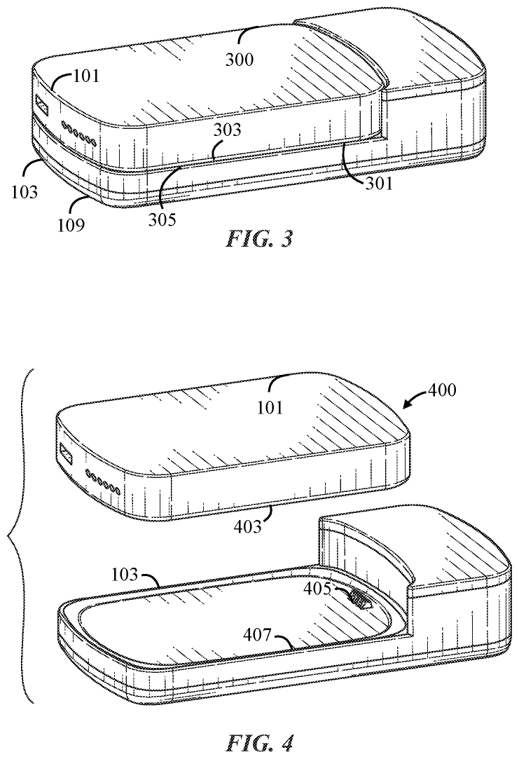

FIG. 3 illustrates a perspective view of the portable wireless charger 101 and wireless charging base 103. The bottom 300 of the portable wireless charger 101 is a flat surface to contact the back of the electronic device. When in the connected configuration 109, bottom 300 of the portable wireless charger and bottom surface 301 of the wireless charging base 103 form a flat planar surface. The portable wireless charger 101 and wireless charging base 103 include complimentary edges 303, 305 to have a seamless and streamline appearance when connected.

FIG. 4 illustrates an exploded view of the portable wireless charger 101 and wireless charging base 103 wherein the portable wireless charger 101 is disconnected from the wireless charging base 103. The portable wireless charger 101 may charge the electronic device when in a disconnected configuration 400 such that the portable wireless charger 101 may charge the electronic device without the need to be connected to the wireless charging base 103. In such, the user may transport or otherwise travel with the portable wireless charger 101 to charge their electronic device without the wireless charging base 103. The portable wireless charger 101 may be periodically connected to the wireless charging base 103 to recharge the rechargeable battery therein. The first surface 403 of the portable wireless charger 101 includes a female port (not shown) which connects to the male port 405 provided on the receiver portion 407 of the wireless charging base 103.

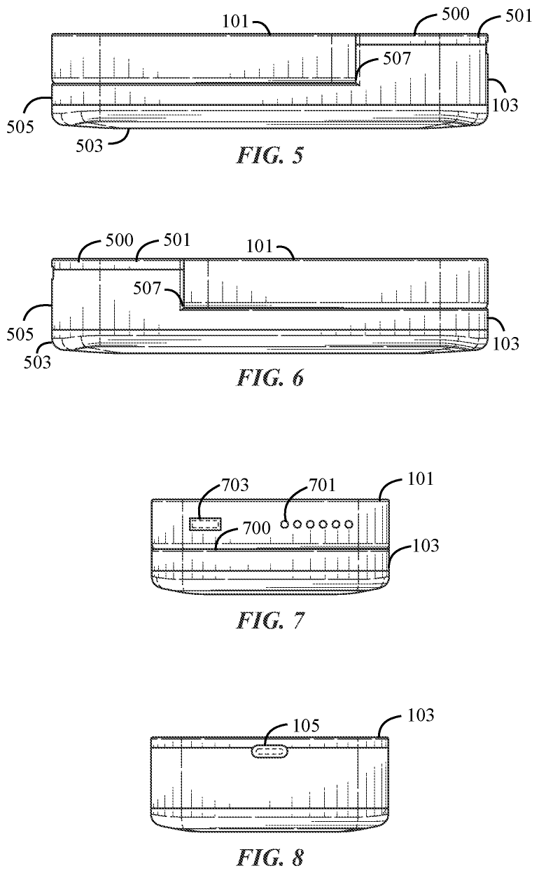

FIG. 5 and FIG. 6 illustrate side elevation views of the portable wireless charger 101 and wireless charging base 103. The housing 500 of the wireless charging base includes a top portion 501 and a bottom portion 503 separated by a central portion 505. The central portion 505 is configurated having an L-shaped edge 507 to receive the portable wireless charger 101 when connected.

FIG. 7 illustrates a front side 700 elevation view of the portable wireless charger 101 and wireless charging base 103. The front side 700 of the portable wireless charger includes a charging indicator 701 which may be comprised of a plurality of LED's or other lighting element. The charging indicator 701 may illuminate or partially illuminate to indicate a power level within the power storage. A status indicator 703 is also positioned on the front side 700 to indicate a status (e.g., ON/OFF, charged, low battery, etc.) of the device. FIG. 8 illustrates a rear side elevation of the wireless charging base 103 having the first port 105 positioned thereon.

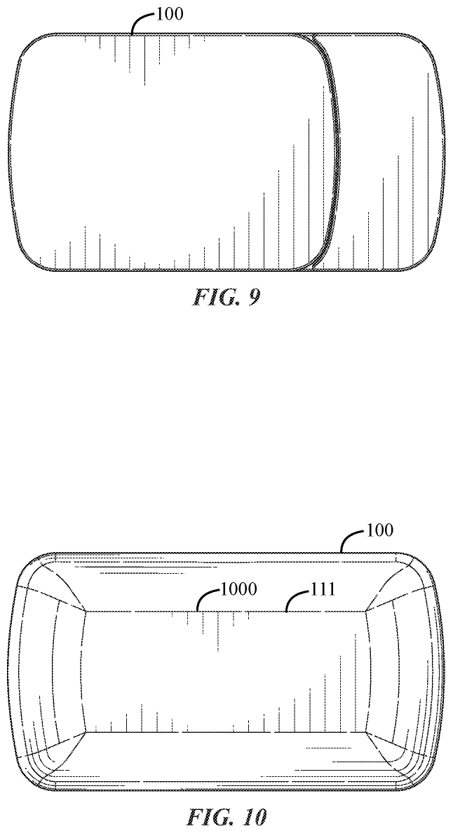

FIG. 9 and FIG. 10 illustrates a bottom plan view and top plan view of the device 100. As shown in FIG. 10, the upper surface 111 of the wireless charging base 103 includes a domed surface 1000, to provide sufficient space therein to house the electrical components and power storage device.

In some embodiments, the device 100 is constructed as an annular ring positioned within the portable wireless charger 101. The annular ring may provide wireless charging capabilities while functioning as a power storage device. The annular ring may be positioned within the housing such that the housing is molded around the annular ring or may be positioned on the exterior of the housing.

The device 100 may be readily attached to the electronic device 200 when supplemental power is needed. Further, the device 100 is lightweight and easily portable to allow normal transport of the electronic device during daily activities.

In some embodiments, additional transmitter and receiver circuitry may be provided to allow wireless power to be transferred bidirectionally.

The device 100 may further be capable of receiving power from an external power source, either by wired connection or wirelessly via the portable wireless charger 101 to replenish the power storage component and allow the device 100 to be reused for the purpose of transmitting supplemental power to the electronic device 200 after the portable wireless charger 101 has been depleted from use during charging.

Wireless communications circuitry can use one or more coils (e.g., coils in transmitter circuitry TX and/or receiver circuitry RX) to transmit and/or receive in-band signals. Any suitable modulation scheme may be used to support in-band communications between devices electronic devices. In some embodiments, frequency-shift keying (FSK) is used to convey in-band data from a power transmitting circuit to a power receiving circuit (e.g., the frequency of wireless power signals may be modulated when power is being transmitted from the power transmitting circuit to the power receiving circuit) and amplitude-shift keying (ASK) is used to convey in-band data from a wireless power receiving circuit to a wireless power transmitting circuit. Power may be conveyed wirelessly between devices during these FSK and ASK transmissions. Other types of in-band communications may be used, if desired.

The electronic device 200 may include input-output circuitry as shown by input-output devices. Input-output devices may include light-based devices (e.g., displays, status indicator lights formed from light-emitting diodes or other light emitters, ambient light sensors, image sensors, optical proximity sensors, three-dimensional image sensors formed from light emitters that project beams of light and corresponding image sensors that detect dots where the projected light beams strike objects, camera flash components, and/or other circuits that emit and/or detect light), radio-frequency circuitry (e.g., radio-frequency circuitry such as radar circuitry and/or other radio-frequency circuitry for detecting the location and movement of objects), acoustic components (e.g., microphones for gathering sound and speakers for emitting sound), haptic output devices for providing vibrations and other haptic output, touch sensors, buttons, force sensors, joysticks, knobs, temperature sensors, and/or other circuitry for detecting user input and for measuring environmental data.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A portable charger for an electronic device, the device comprising:
a wireless charging base configured to store supplemental power and transmit the supplemental power to a portable wireless charger, the portable wireless charger in electrical communication with the wireless charging base, the portable wireless charger configured to wirelessly transmit the stored supplemental power wirelessly to an electronic device, and the portable wireless charger releasably engaged via a port to the wireless charging base.

2. The portable charger for an electronic device of claim 1, further comprising a housing.

3. The portable charger for an electronic device of claim 2, wherein the wireless charging base and the portable wireless charger are configurable in a connected configuration and a disconnected configuration.

4. The portable charger for an electronic device of claim 3, wherein the portable wireless charger supplies power to the electronic device when in the disconnected configuration.

5. The portable charger for an electronic device of claim 3, wherein the portable wireless charger supplies power to the electronic device when in the connected configuration.

6. The portable charger for an electronic device of claim 1, wherein the portable power supply is disposed within the housing and the wireless charger is disposed on the exterior of the housing.

7. The portable charger for an electronic device of claim 1, wherein the housing is a protective case.

8. The portable charger for an electronic device of claim 1, wherein a power storage is disposed within the wireless charging base.

9. The portable charger for an electronic device of claim 1, wherein the portable wireless charger and the wireless charging base are releasably engaged via a male port position on the wireless charging base and a female port on the portable wireless charger.

10. The portable charger for an electronic device of claim 1, wherein the portable wireless charger includes a front side, the front side including a charging indicator.

11. The portable charger for an electronic device of claim 10, wherein the charging indicator is comprised of a plurality of LED's.

12. A portable charger for an electronic device, the device comprising:
a wireless charging base configured to store supplemental power and transmit the supplemental power to a portable wireless charger, the portable wireless charger in electrical communication and releasably connected to the wireless charging base, the portable wireless charger configured to wirelessly transmit the stored supplemental power to an electronic device, and the portable wireless charger releasably engaged via a male port and a female port to the wireless charging base;
a first port positioned on a rear side of the wireless charging base; and
a status indicator positioned on a front side of the wireless charging base to indicate a status,
wherein the wireless charging base and the portable wireless charger form a planar surface when configured in a connected configuration.

13. The portable charger for an electronic device of claim 12, further comprising a housing.

14. The portable charger for an electronic device of claim 13, wherein the wireless charging base and the portable wireless charger are configurable in the connected configuration and a disconnected configuration.

15. The portable charger for an electronic device of claim 14, wherein the portable wireless charger supplies power to the electronic device when in the disconnected configuration.

16. The portable charger for an electronic device of claim 15, wherein the portable wireless charger supplies power to the electronic device when in the connected configuration.

17. The portable charger for an electronic device of claim 16, wherein the portable power supply is disposed within the housing and the wireless charger is disposed on the exterior of the housing.

18. The portable charger for an electronic device of claim 17, wherein the housing is a protective case.

19. The portable charger for an electronic device of claim 18, wherein the portable wireless charger and the wireless charging base are releasably engaged via a male port position on the wireless charging base and a female port on the portable wireless charger.

20. The portable charger for an electronic device of claim 19, wherein the portable wireless charger includes a front side, the front side including a charging indicator.
